(19) United States
(12) Patent Application Publication
(10) Pub. No.: US 2026/0227663 A1
(43) Pub. Date: Aug. 6, 2026

(54) LIQUID CRYSTAL DISPLAY PANEL

(71) Applicant: Wuhan China Star Optoelectronics Technology Co., Ltd., Wuhan, Hubei (CN)

(72) Inventors: Xiaochen LI, Wuhan, Hubei (CN); Xiaoxu LIAN, Wuhan, Hubei (CN)

(73) Assignee: Wuhan China Star Optoelectronics Technology Co., Ltd., Wuhan, Hubei (CN)

(21) Appl. No.: 18/695,837

(22) PCT Filed: Feb. 18, 2024
(86) PCT No.: PCT/CN2024/077374

§ 371 Date: Apr. 27, 2026

(30) Foreign Application Priority Data
Feb. 4, 2024 (CN) 202410158642.8

(51) Int. Cl. G02F 1/1362; G02F 1/1368

(52) U.S. Cl. CPC G02F 1/136209; G02F 1/13624; G02F 1/136286; G02F 1/1368

(57) ABSTRACT

Embodiments of the present disclosure disclose a liquid crystal display panel. In the liquid crystal display panel of the embodiments of the present disclosure, in an orthographic projection pattern of the liquid crystal display panel, first shielding portions of a black matrix layer completely cover adjacent two scanning lines, thin film transistor connected to the adjacent two scanning lines, and paddings.

### TECHNICAL FIELD

The present disclosure relates to the field of display, and in particular, to a liquid crystal display panel.

### BACKGROUND

In the art, the aperture ratio of a liquid crystal display panel is usually affected by three factors. The first factor is a base of a black matrix layer below a padding (PS). A size of the base is limited to the mechanical testing ability of products including the base. To ensure the mechanical testing ability, the base of the black matrix layer usually needs to shield the padding for a certain safety distance. The second factor is a width of the black matrix layer in a scanning line direction, which is mainly limited by the design of thin film transistors (TFTs) and the control of the safety distance. The black matrix layer needs to shield metal wirings in the scanning line direction. The third factor is a width of the black matrix layer in a data line direction. Generally, the width of the black matrix layer in the data line direction is influenced by factors such as product charging rate, touch performance, and the like.

Since the limited upper limit of the increase in the aperture ratio, a new configuration is needed to improve the aperture ratio.

### SUMMARY

Embodiments of the present disclosure provide a liquid crystal display panel, which can improve an aperture ratio of products including the liquid crystal display panel without sacrificing performance of the products.

Embodiments of the present disclosure provide a liquid crystal display panel, including:
a black matrix layer provided with a plurality of pixel openings, in which the black matrix layer includes a plurality of first shielding portions disposed along a first direction, and the first shielding portions are disposed between adjacent two rows of pixel openings;
an array substrate including a plurality of pixel electrodes, a plurality of scanning lines disposed along the first direction, and a plurality of thin film transistors, in which the pixel electrodes are disposed corresponding to the pixel openings; in an orthographic projection pattern of the liquid crystal display panel, adjacent two scanning lines are disposed between adjacent two rows of pixel openings, and the first shielding portions cover the scanning lines and the thin film transistors; and the scanning lines are connected to gates of the thin film transistors; and
a plurality of paddings disposed on the array substrate, in which in the orthographic projection pattern of the liquid crystal display panel, the first shielding portions cover the paddings.

### BRIEF DESCRIPTION OF THE DRAWINGS

FIG. 1 is a schematic diagram of an orthographic projection of a liquid crystal display panel in prior art;

FIG. 2 is a schematic cross-sectional structural diagram of a liquid crystal display panel provided in embodiments of the present disclosure;

FIG. 3 is a schematic structural diagram of an orthographic projection of a liquid crystal display panel provided in embodiments of the present disclosure;

FIG. 4 is an enlarged view of part A in FIG. 3;

FIG. 5 is a schematic diagram of FIG. 4 removing paddings and pixel electrodes;

FIG. 6 is a schematic diagram of a black matrix layer in FIG. 3;

FIG. 7 is another schematic cross-sectional structural diagram of a liquid crystal display panel provided in embodiments of the present disclosure;

FIG. 8 is an enlarged view of part A in FIG. 7;

FIG. 9 is a schematic diagram of FIG. 7 removing paddings and pixel electrodes.

### DETAILED DESCRIPTION

In combination with drawings in the embodiments of the present disclosure, technical solutions in the embodiments of the present disclosure will be described clearly and fully. Apparently, the described embodiments are only part of the embodiments of the present disclosure, not all of them. Based on the embodiments of the present disclosure, all other embodiments obtained by those skilled in the art without creative effort belong to the scope of the present disclosure. In addition, it should be understood that specific embodiments described herein are only used to explain and interpret the present disclosure and are not used to limit the present disclosure. In the present disclosure, the directional terms used, such as “up” and “down”, generally refer to up and down directions of the device in use or working state, in particular the directions shown in the drawings; and terms “inside” and “outside” refer to outlines of the devices, unless otherwise described. Terms “first”, “second”, “third”, and the like are only used as indications and do not impose numerical requirements or establish orders.

The embodiments of the present disclosure provide a liquid crystal display panel, which will be described in detail below. It should be noted that the order of describing the following embodiments should not be taken as a limitation on a preferred order of the embodiments.

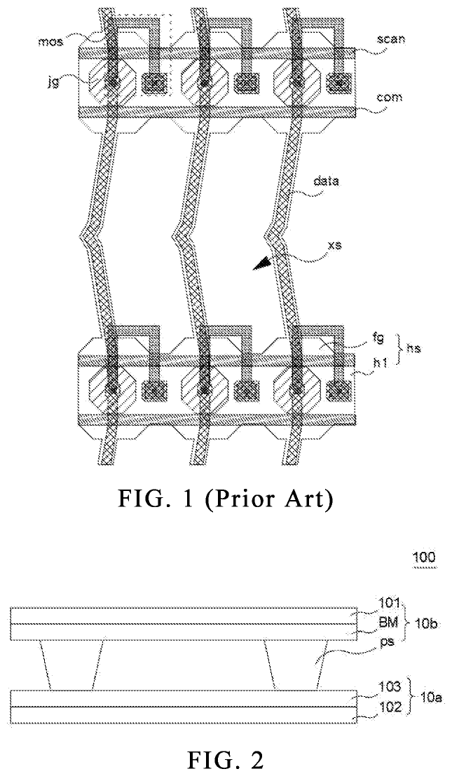

Referring to FIG. 1, in a prior art liquid crystal panel, a region where a single scanning line scan, thin film transistors mos connected to the single scanning line scan, and a common electrode line com are located, is defined as a row region, and a region where a pixel electrode is located is defined as a pixel region xs. In an extension direction of a data line data, the row region and a row of pixel electrodes are alternately arranged. A padding jg is disposed corresponding to the row region. A part of a black matrix layer hs corresponding to the padding jg is a base fg, and a part of the black matrix layer hs corresponding to the row region is a row shielding portion h1. Because the base fg needs to shield the padding jg, a certain safety distance is needed, and a width of the base fg is usually greater than 20 microns and a width of the row shielding portion h1 is usually less than 20 microns, which causes the base in each row region exceeding the row shielding portion, resulting in a waste of openings.

In a liquid crystal display panel provided in the embodiments of the present disclosure, in an orthographic projection pattern of the liquid crystal display panel, two rows of pixel electrodes are disposed between adjacent two row line groups, paddings are stacked on a row line group, and first shielding portions of a black matrix layer completely cover the row line group and the paddings. In the present disclosure, paddings, two scanning lines, and thin film transistors connected to the two scanning lines are disposed in the region where one row line group is located, so that the first shielding portions cover the paddings, two scanning lines, and the thin film transistors connected to the two scanning lines. Compared with the design of the single scanning line, the present disclosure avoids the excessive waste of the aperture ratio caused by a width of the region where the paddings in each row are located exceeding a width of the region where the single scanning line is located, thereby improving the aperture ratio of the liquid crystal display panel without sacrificing performances of products, such as reducing sizes of scanning lines and thin-film transistors.

Embodiments of the present disclosure provide a liquid crystal display panel including:
a black matrix layer provided with a plurality of pixel openings, in which the black matrix layer includes a plurality of first shielding portions disposed along a first direction, and the first shielding portions are disposed between adjacent two rows of pixel openings;
an array substrate including a plurality of pixel electrodes, a plurality of scanning lines disposed along the first direction, and a plurality of thin film transistors, in which the pixel electrodes are disposed corresponding to the pixel openings; in an orthographic projection pattern of the liquid crystal display panel, adjacent two scanning lines are disposed between adjacent two rows of pixel openings, and the first shielding portions cover the scanning lines and the thin film transistors; and the scanning lines are connected to gates of the thin film transistors; and
a plurality of paddings disposed on the array substrate, in which in the orthographic projection pattern of the liquid crystal display panel, the first shielding portions cover the paddings.

Optionally, in some embodiments of the present disclosure, two rows of pixel openings are disposed between adjacent two first shielding portions, the array substrate further includes a plurality of common electrode lines extending along the first direction, one of the common electrode lines is disposed between two rows of pixel openings and between two first shielding portions; and
the black matrix layer further includes a plurality of third shielding portions covering the common electrode lines.

Optionally, in some embodiments of the present disclosure, the array substrate further includes a plurality of data lines disposed along a second direction intersecting with the first direction;
in the orthographic projection pattern of the liquid crystal display panel, the data lines intersect with the scanning lines and the common electrode lines, respectively; one of the pixel electrodes includes a first pixel electrode and a second pixel electrode; the first pixel electrode corresponds to one of the pixel openings, the second pixel electrode corresponds to one of the pixel openings; one of the scanning lines includes a first scanning line and a second scanning line; one of the thin film transistors includes a first thin film transistor and a second thin film transistor; a gate of the first thin film transistor is connected to the first scanning line, a gate of the second thin film transistor is connected to the second scanning line, an output pole of the first thin-film transistor is connected to the first pixel electrode, and an output pole of the second thin-film transistor is connected to the second pixel electrode; one of the common electrode lines is spaced between a side of the first pixel electrode away from the first thin-film transistor and a side of the second pixel electrode away from the second thin-film transistor, and the first scanning line and the second scanning line are spaced between a side of the first pixel electrode close to the first thin film transistor and a side of the second pixel electrode close to the second thin film transistor; and
the black matrix layer includes a plurality of second shielding portions, and the first shielding portions intersect with and are connected to the second shielding portions; in the orthographic projection pattern of the liquid crystal display panel, one of the first shielding portions, one of the pixel openings, one of the third shielding portions, and another one of the pixel openings are alternately arranged in a direction perpendicular to the first direction, and the second shielding portions covers the data lines.

Optionally, in some embodiments of the present disclosure, in the orthographic projection pattern of the liquid crystal display panel, a plurality of paddings are arranged in rows along the first direction, and a row of first pixel electrodes and a row of second pixel electrodes are disposed between adjacent two rows of the paddings in the direction perpendicular to the first direction.

Optionally, in some embodiments of the present disclosure, in the orthographic projection pattern of the liquid crystal display panel, one of the paddings is disposed at an intersection of one of the first shielding portions and one of the second shielding portions; and
the paddings partially overlap with the first scanning line, the second scanning line, and one of the data lines.

Optionally, in some embodiments of the present disclosure, in the orthographic projection pattern of the liquid crystal display panel, in the direction perpendicular to the first direction, a region where the paddings are located has a first width, a region where the first scanning line and the first thin film transistor connected thereto are located has a second width, a region where the second scanning line and the second thin film transistor connected thereto are located has a third width, and the first width is greater than the second width and the third width and less than or equal to a sum of the second width and the third width.

Optionally, in some embodiments of the present disclosure, in the orthographic projection pattern of the liquid crystal display panel, the first thin-film transistor is disposed at a side of the first scanning line away from the second scanning line, and the second thin-film transistor is disposed at a side of the second scanning line away from the first scanning line and aligned with the first thin-film transistor.

Optionally, in some embodiments of the present disclosure, the first scanning line includes a first main line and at least one first extension portion, the first extension portion is connected to a side of the first main line away from the second scanning line and the gate of the first thin film transistor; and
the first thin film transistor includes a first active layer, and in the orthographic projection pattern of the liquid crystal display panel, the first active layer overlaps with the gate of the first thin film transistor.

Optionally, in some embodiments of the present disclosure, the first active layer extends along an extension direction of the first main line, an extension direction of the first extension portion intersects with the extension direction of the first main line, and the first active layer overlaps with two first extension portions.

Optionally, in some embodiments of the present disclosure, the second scanning line includes a second main line and at least one second extension portion, the second extension portion is connected to a side of the second main line away from the first scanning line, and the second extension portion is multiplexed as the gate of the second thin film transistor; and
the second thin film transistor includes a second active layer, and in the orthographic projection pattern of the liquid crystal display panel, the second active layer overlaps with the second extension portion.

Optionally, in some embodiments of the present disclosure, the second active layer extends along an extension direction of the second main line, an extension direction of the second extension portion intersects with the extension direction of the second main line, and the second active layer overlaps with two second extension portions.

Optionally, in some embodiments of the present disclosure, in the orthographic projection pattern of the liquid crystal display panel, the first thin film transistor partially overlaps with the second thin film transistor along the first direction;
one of the first shielding portions includes a base and a row shielding portion connected to the base; in the orthographic projection pattern of the liquid crystal display panel, the base completely covers one of the paddings, the base covers a part of one of the scanning lines and one of the thin film transistors, and the row shielding portion covers another part of the one of the scanning lines and the one of the thin film transistors;
a width of the base is greater than a width of the row shielding portion in the direction perpendicular to the first direction. Optionally, in some embodiments of the present disclosure, the first thin film transistor includes a first active layer, the first active layer includes a first portion and a second portion connected to the first portion, and an extension direction of the first portion intersects with an extension direction of the second portion; and
the first scanning line overlaps with the first portion and the second portion, and a part of the first scanning line overlapping with the first portion and the second portion is multiplexed as the gate of the first thin film transistor.

Optionally, in some embodiments of the present disclosure, the first scanning line includes a plurality of first turning portions and a first connecting portion connected between adjacent two first turning portions, and each of the first turning portions includes a first segment, a second segment, and a third segment sequentially connected to each other; an extension direction of the first segment intersects with an extension direction of the second segment, the extension direction of the second segment intersects with an extension direction of the third segment; and both of the first segment and the third segment are connected to a side of the second segment close to the second scanning line, an end of the first connecting portion is connected to the first segment of one of the first turning portions, and another end of the first connecting portion is connected to the third segment of another one of the first turning portions; and
the first connecting portion overlaps with the first portion, and the first segment overlaps with the second portion.

Optionally, in some embodiments of the present disclosure, the second thin film transistor includes a second active layer, the second active layer includes a third portion and a fourth portion connected to the third portion, and an extension direction of the third portion intersects with an extension direction of the fourth portion; and
the second scanning line overlaps with the third portion and the fourth portion, and a part of the second scanning line overlapping with the third portion and the fourth portion is multiplexed as the gate of the second thin film transistor.

Optionally, in some embodiments of the present disclosure, the second scanning line includes a plurality of second turning portions and a second connecting portion connected between adjacent two second turning portions, and each of the second turning portions includes a fourth segment, a fifth segment, and a sixth segment sequentially connected to each other; an extension direction of the fourth segment intersects with an extension direction of the fifth segment, the extension direction of the fifth segment intersects with an extension direction of the sixth segment; and both of the fourth segment and the sixth segment are connected to a side of the fifth segment away from the first scanning line, an end of the second connecting portion is connected to the fourth segment of one of the second turning portions, and another end of the second connecting portion is connected to the sixth segment of another one of the second turning portions; and
the fourth segment overlaps with the third portion, and the fifth segment overlaps with the fourth portion.

Optionally, in some embodiments of the present disclosure, the first turning portions are aligned with the second turning portions in the direction perpendicular to the first direction, and the first connecting portion is aligned with the second connecting portion; and
along the first direction, the extension direction of the fifth segment and an extension direction of the first connecting portion are the same, the fifth segment and the first connecting portion are alternately arranged, and the fifth segment is aligned with the first connecting portion.

Optionally, in some embodiments of the present disclosure, the first portion intersects with and is connected to the third portion, the first thin film transistor and the second thin film transistor share a common input pole, and the common input pole is connected to one of the data lines and connected to an intersection of the first portion and the third portion.

Optionally, in some embodiments of the present disclosure, one of the data lines is connected to the common input pole through a first via, and in the orthographic projection pattern of the liquid crystal display panel, one of the data lines, the first via, and the common input pole are disposed overlapping with each other.

Optionally, in some embodiments of the present disclosure, the output pole of the first thin-film transistor and the output pole of the second thin-film transistor are adjacent in a region defined by one of the first turning portions and the fifth segment, and the common input pole is disposed between the first connecting portion and the second connecting portion.

Optionally, in some embodiments of the present disclosure, the liquid crystal display panel further includes an opposing substrate disposed opposite to the array substrate, the black matrix layer is integrated into the opposing substrate or the array substrate, and the paddings are integrated into the opposing substrate or the array substrate.

In the liquid crystal display panel of the embodiments of the present disclosure, in the orthographic projection pattern of the liquid crystal display panel, the first shielding portions of the black matrix layer completely cover adjacent two scanning lines and the thin film transistors connected thereto, and the paddings. In the present disclosure, the paddings, two scanning lines, and thin film transistors connected to the two scanning lines are disposed in the region covered by the first shielding portions, so that the first shielding portions cover the paddings, the two scanning lines, and the thin film transistors connected to the two scanning lines. Compared with the design of the single scanning line, the present disclosure avoids the excessive waste of the aperture ratio caused by a width of the region where the paddings in each row are located exceeding a width of the region where the single scanning line is located, thereby improving the aperture ratio of the liquid crystal display panel without sacrificing performances of products.

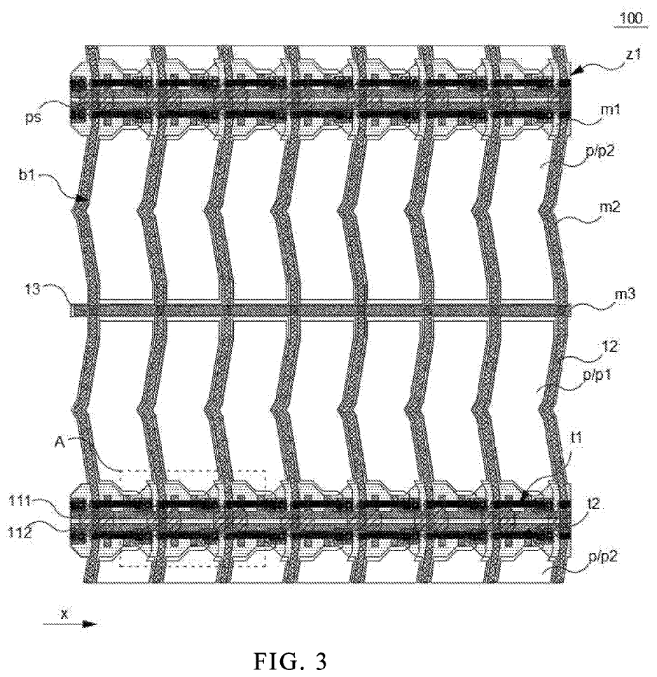

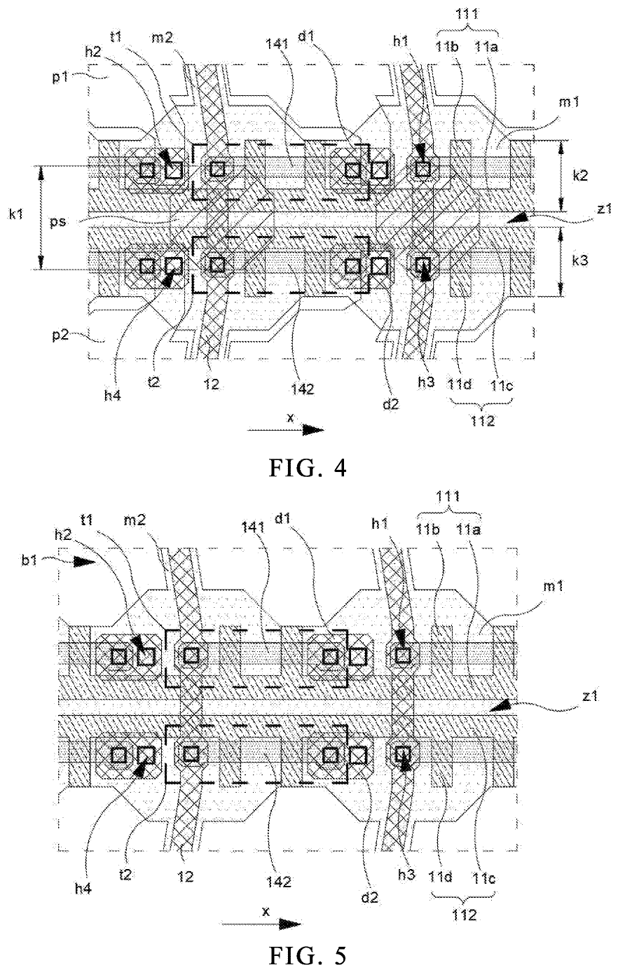

Referring to FIGS. 2 to 4, the embodiments of the present disclosure provide a liquid crystal display panel 100 including an array substrate 10a, multiple paddings ps, and a black matrix layer BM.

The black matrix layer BM is provided with multiple pixel openings b1. The black matrix layer BM includes multiple first shielding portions m1 disposed along a first direction x, and the first shielding portions m1 are disposed between adjacent two rows of pixel openings b1.

The array substrate 10a includes multiple pixel electrodes p, multiple scanning lines disposed along the first direction x, and multiple thin film transistors. The pixel openings b1 are disposed corresponding to the pixel electrodes p. In an orthographic projection pattern of the liquid crystal display panel 100, adjacent two scanning lines are disposed between adjacent two rows of pixel openings b1, and the first shielding portions m1 cover the scanning lines and the thin film transistors. The scanning lines are connected to gates of the thin film transistors.

The paddings ps are disposed on the array substrate 10a. In the orthographic projection pattern of the liquid crystal display panel 100, the first shielding portions m1 cover the paddings ps.

In the liquid crystal display panel 100 of the embodiments of the present disclosure, in the orthographic projection pattern of the liquid crystal display panel 100, the first shielding portions m1 of the black matrix layer BM completely cover adjacent two scanning lines and the thin film transistors connected thereto, and the paddings ps. In the present disclosure, the first shielding portions are configured to shield the paddings ps, two scanning lines, and thin film transistors connected to the two scanning lines, so that the paddings ps, the two scanning lines, and the thin film transistors connected to the two scanning lines are disposed in the region covered by the first shielding portions. Compared with the design of the single scanning line, the present disclosure avoids the excessive waste of the aperture ratio caused by a width of the region where the paddings ps in each row are located exceeding a width of the region where the single scanning line is located, thereby improving the aperture ratio of the liquid crystal display panel 100 without sacrificing performance of display panels.

Optionally, adjacent two scanning lines and the thin film transistors connected thereto define a row line group z1. The scanning lines include a first scanning line 111 and a second scanning line 112. One of the thin film transistors include a first thin film transistor t1 and a second thin film transistor t2. A gate of the first thin film transistor t1 is connected to the first scanning line 111. A gate of the second thin film transistor t2 is connected to the second scanning line 112.

The paddings ps are stacked on the row line group z1.

In an embodiment, in the orthographic projection pattern of the liquid crystal display panel 100, the first shielding portions m1 completely cover the row line group z1 and the paddings ps.

In an embodiment, the liquid crystal display panel 100 includes an opposing substrate 10b disposed opposite to the array substrate 10a. The black matrix layer BM is integrated into the opposing substrate 10b or the array substrate 10a, and the paddings ps are integrated into the opposing substrate 10b or the array substrate 10a.

For example, the black matrix layer BM is integrated into the opposing substrate 10b, and the paddings ps are integrated into the array substrate 10a and disposed on a side of the thin film transistor layer close to the opposing substrate 10b.

For example, the black matrix layer BM and the paddings ps are integrated into the array substrate 10a. The black matrix layer BM is disposed on a side of the thin film transistor layer close to the opposing substrate 10b, and the paddings ps are disposed on a side of the black matrix layer BM close to the opposing substrate 10b.

For example, the black matrix layer BM is integrated into the array substrate 10a, and the paddings ps are integrated into the opposing substrate 10b. The black matrix layer BM is disposed on a side of the thin film transistor layer close to the opposing substrate 10b.

For example, the black matrix layer BM and the paddings ps are integrated into the opposing substrate 10b. Taking this embodiment as an example, the opposing substrate 10b includes a first substrate 101, the black matrix layer BM, and the paddings ps, the black matrix layer BM is disposed on a side of the first substrate 101 close to the array substrate 10a, and the paddings ps are disposed on a side of the black matrix layer BM close to the array substrate 10a.

In an embodiment, the array substrate 10a includes a second substrate 102 and a thin film transistor layer 103 disposed on a side of the second substrate 102 close to the opposing substrate 10b. The thin film transistor layer 103 includes the first scanning line 111, the second scanning line 112, multiple first thin film transistors t1, and multiple second thin film transistors t2.

Optionally, the first scanning line 111, the second scanning line 112, the gate of the first thin-film transistor t1, and the gate of the second thin-film transistor t2 are disposed in the same layer, and formed using the same mask process.

In an embodiment, two rows of pixel openings b1 are disposed between adjacent two first shielding portions m1. The array substrate 10a further includes multiple common electrode lines 13 extending along the first direction x. Each of the common electrode lines 13 is disposed between two rows of pixel openings b1 and between two first shielding portions m1.

The black matrix layer BM includes multiple third shielding portions m3 covering the common electrode lines 13.

In the panels with a configuration of the single scanning line, in order to ensure the uniformity of common electrodes, the common electrode line is usually disposed at a side of the single scanning line, that is, each row region is provided with the common electrode line. In the embodiments of the present disclosure, the common electrode line 13 is disposed between adjacent two row of row line groups z1, rather than being integrated into the row line group z1. Therefore, compared with the configuration of the single scanning line, the number of common electrode lines 13 in the embodiments of the present disclosure can be reduced by half while ensuring the uniformity of the common electrodes, thereby further improving the aperture ratio.

The array substrate 10a further includes multiple data lines 12 disposed along a second direction intersecting with the first direction x. The first direction x is the first direction, and the second direction is an extension direction of the data lines 12.

In the orthographic projection pattern of the liquid crystal display panel 100, the data lines 12 intersects with the scanning lines and the common electrode lines 13. The pixel electrode p includes a first pixel electrode p1 and a second pixel electrode p2. The first pixel electrode p1 corresponds to one pixel opening b1, and the second pixel electrode p2 corresponds to another pixel opening b1. An output pole of the first thin-film transistor t1 is connected to the first pixel electrode p1, and an output pole of the second thin-film transistor t2 is connected to the second pixel electrode p2. Each of the common electrode lines 13 is spaced between a side of the first pixel electrode p1 away from the first thin film transistor t1 and a side of the second pixel electrode p2 away from the second thin film transistor t2. The row line group z1 is spaced between a side of the first pixel electrode p1 close to the first thin film transistor t1 and a side of the second pixel electrode p2 close to the second thin film transistor t2.

The black matrix layer BM further includes multiple second shielding portions m2. The second shielding portions m2 intersect with and are connected to the third shielding portions m3. The first shielding portions m1 intersect with and are connected to the second shielding portions m2.

In the orthographic projection pattern of the liquid crystal display panel 100, one of the first shielding portions m1, one of the pixel openings b1, one of the third shielding portions m3, and another one of the pixel openings b1 are alternately arranged in a direction perpendicular to the first direction x. The second shielding portions m2 cover the data lines 12. The third shielding portions m3 cover the common electrode lines 13.

Optionally, the second shielding portion m2 completely covers the data line 12. The third shielding portion m3 completely covers the common electrode line 13.

In the black matrix layer BM, the first shielding portions m1 and the third shielding portions m3 are alternately arranged in the direction perpendicular to the first direction. The second shielding portion m2 intersects with and is connected to the first shielding portion m1 and the third shielding portion m3, respectively. Adjacent two second shielding portions, one first shielding portion m1, and one third shielding portion m3 are connected to form one pixel opening b1.

Optionally, a width v1 of the third shielding portion m3 is less than a width v2 of the first shielding portion m1.

Optionally, the data line 12, the input pole and the output pole of the first thin film transistor t1, and the input pole and the output pole of the second thin film transistor t2 are disposed in the same layer and formed in the same mask process.

It can be understood that when one of an input pole and an output pole of a thin film transistor is a source, the other of the input pole and the output pole of the thin film transistor is a drain. The present disclosure takes the input pole of the thin film transistor as the source and the output pole of the thin film transistor as the drain as an example, but not limited thereto.

Optionally, the data line 12 is connected to the input pole of the first thin film transistor t1 and the input pole of the second thin film transistor.

In an embodiment, in the orthographic projection pattern of the liquid crystal display panel 100, multiple paddings ps are arranged in rows along the first direction x. In the direction perpendicular to the first direction x, a row of first pixel electrodes p1 and a row of second pixel electrodes p2 are disposed between adjacent two rows of padding ps.

That is, two rows of pixel electrodes p are spaced between adjacent two rows of paddings ps. The embodiments of the present disclosure reduce the number of the paddings ps by arranging the paddings ps in an interval manner, which can improve the aperture ratio.

In an embodiment, in the orthographic projection pattern of the liquid crystal display panel 100, the paddings ps are disposed at intersections of the first shielding portions m1 and the second shielding portions m2.

Each of the paddings ps partially overlaps with the first scanning line 111, the second scanning line 112, and the data line 12.

By setting the paddings ps at the intersections of the first shielding portions m1 and the second shielding portions m2, on one hand, it facilitates the positioning of the paddings ps to ensure the uniform arrangement of the paddings ps, on the other hand, when the paddings ps are offset due to errors, the second shielding portions m2 can compensate for the shielding caused by the offset of the paddings ps.

Optionally, an intersection part of the first shielding portion m1 and the second shielding portion m2 is provided with a base dz of the padding ps, and the base dz is used to support and shield the padding ps.

In the orthographic projection pattern of the liquid crystal display panel 100, the base dz completely shields the padding ps. The first shielding portion m1 includes the base dz and a row shielding portion m11 connected between adjacent two bases dz. The second shielding portion m2 includes another base dz and a column shielding portion m21 connected between adjacent two base dz.

A width of the base dz is greater than a width of the column shielding portion m21 in the first direction x, and a width of the base dz is greater than a width of the row shielding portion m11 in the direction perpendicular to the first direction x. This setting ensures that the base dz completely covers the padding ps.

In an embodiment, in the orthographic projection pattern of the liquid crystal display panel 100, in the direction perpendicular to the first direction x, a region where the padding ps is located has a first width k1, a region where the first scanning line 111 and the first thin film transistor t1 connected thereto are located has a second width k2, and a region where the second scanning line 112 and the second thin film transistor t2 connected thereto are located has a third width k3. The first width k1 is greater than the second width k2 and the third width k3, and less than or equal to a sum of the second width k2 and the third width k3.

By changing the structure of the thin film transistors to reduce an area of a single thin film transistor, the aperture ratio is further increased.

In an embodiment, in the same row line group z1, the first thin film transistor t1 and the second thin film transistor t2 are arranged back-to-back with the first scanning line 111 and the second scanning line 112 separated.

That is, in the orthographic projection pattern of the liquid crystal display panel 100, in the same row line group z1, the first thin-film transistor t1 is disposed at a side of the first scanning line 111 away from the second scanning line 112, and the second thin-film transistor t2 is disposed at a side of the second scanning line 112 away from the first scanning line 111 and aligned with the first thin-film transistor t1.

The first thin film transistor t1 and the second thin film transistor t2 are disposed back-to-back, which can save space in the row direction, thereby improving resolution.

In an embodiment, the first scanning line 111 includes a first main line 11a and at least one first extension portion 11b. The first extension 11b is connected to a side of the first main line 11a away from the second scanning line 112 and connected to the gate of the first thin film transistor t1.

The first thin film transistor t1 includes a first active layer 141. In the orthographic projection pattern of the liquid crystal display panel 100, the first active layer 141 overlaps with the gate of the first thin film transistor t1.

Optionally, both of the first active layer 141 and the first main line 11a extend along the first direction x to reduce the width of the region where the first thin film transistor t1 is located, thereby improving the aperture ratio.

In an embodiment, the first active layer 141 extends along an extension direction of the first main line 11a, and an extension direction of the first extension portion 11b intersects with the extension direction of the first main line 11a. The first active layer 141 overlaps with gates of two first thin film transistors t1.

That is, the first thin-film transistor t1 is a double gate thin-film transistor, which improves the turn-on speed of the first thin-film transistor t1.

In an embodiment, the second scanning line 112 includes a second main line 11c and at least one second extension portion 11d. The second extension 11d is connected to a side of the second main line 11c away from the first scanning line 111. The second extension 11d is connected to the gate of the second thin film transistor t2.

The second thin film transistor t2 includes a second active layer 142. In the orthographic projection pattern of the liquid crystal display panel 100, the second active layer 142 overlaps with the gate of the second thin film transistor t2.

Optionally, both of the second active layer 142 and the second main line 11c extend along the first direction x to reduce a width of the region where the second thin film transistor t2 is located, thereby improving the aperture ratio.

In an embodiment, the second active layer 142 extends along an extension direction of the second main line 11c, and an extension direction of the second extension portion 11d intersects with the extension direction of the second main line 11c. The second active layer 142 overlaps with gates of two second thin film transistors 12.

That is, the second thin-film transistor t2 is a double gate thin-film transistor, which improves the turn-on speed of the second thin-film transistor t2.

In an embodiment, the output pole d1 of the first thin film transistor t1 and the output pole d2 of the second thin film transistor t2 are disposed back-to-back, and the input pole of the first thin film transistor t1 and the input pole of the second thin film transistor t2 are disposed back-to-back either.

The output pole d1 of the first thin-film transistor t1 is connected to the first pixel electrode p1, and the output pole d2 of the second thin-film transistor t2 is connected to the second pixel electrode p2.

Optionally, the input pole of the first thin film transistor t1 is connected to the first active layer 141 through one first via h1, and the output pole d1 of the first thin film transistor t1 is connected to the first active layer 141 through another first via h1. The output pole d1 of the first thin-film transistor t1 is connected to the first pixel electrode p1 through a second via h2.

The input pole of the second thin film transistor t2 is connected to the second active layer 142 through one third via h3, and the output pole d2 of the second thin film transistor t2 is connected to the second active layer 142 through another third via h3. The output pole d2 of the second thin film transistor t2 is connected to the second pixel electrode p2 through a fourth via h4.

Optionally, the first thin film transistor t1 and the second thin film transistor t2 can also be single gate structures.

When both of the first active layer 141 of the double gate first thin film transistor t1 and the second active layer 142 of the double gate second thin film transistor t2 are in a straight line shape, the aperture ratio of the liquid crystal display panel provided in the embodiments of the present disclosure can be increased by 6.1% to 10.2% compared with the liquid crystal panel with the configuration of the single scanning line (shown in FIG. 1).

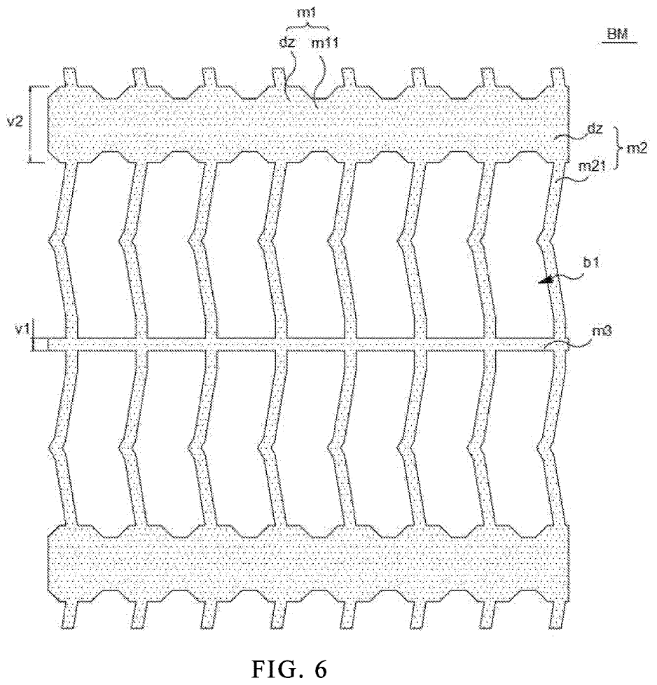

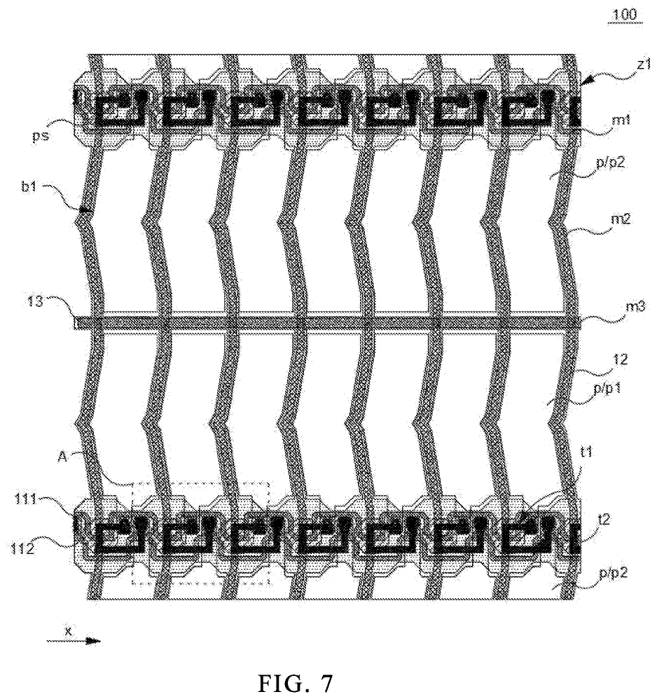

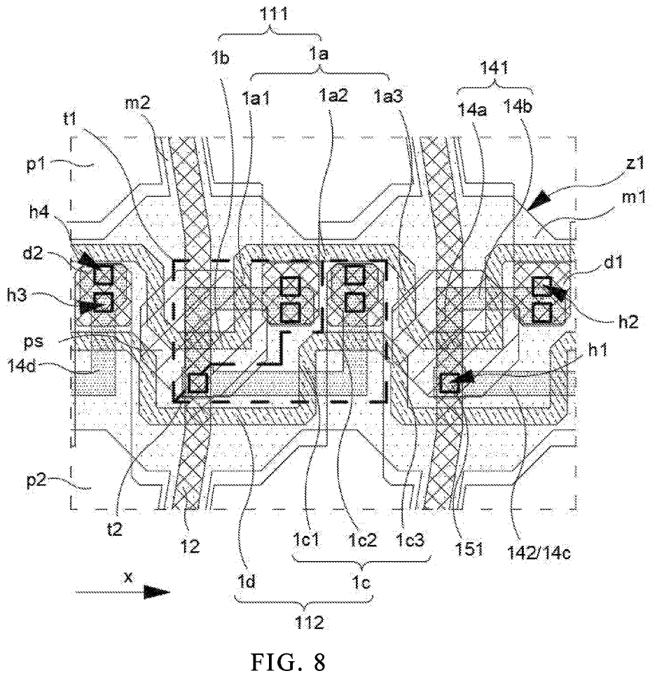

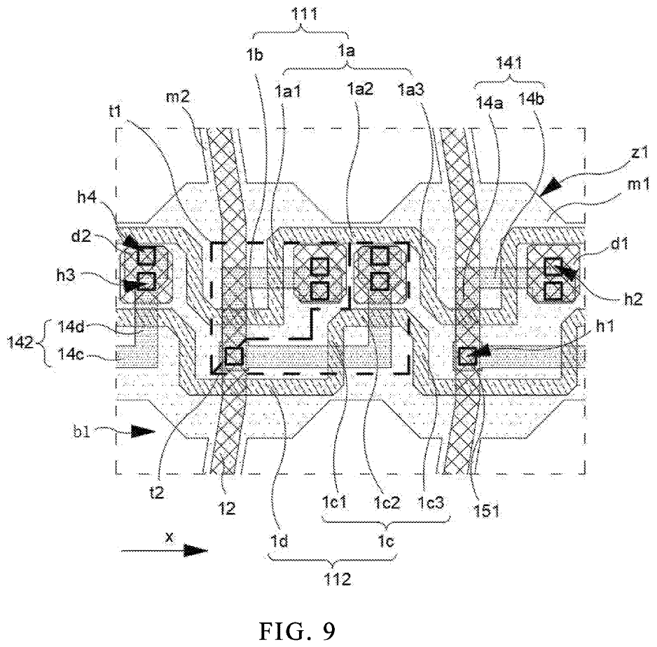

Referring to FIG. 5 and FIG. 6, embodiments different from the above embodiments are provided. In these embodiments, in the orthographic projection pattern of the liquid crystal display panel 100, the first thin film transistor t1 partially overlaps with the second thin film transistor t2 along the first direction x.

Correspondingly, the first shielding portion m1 includes the base dz and the row shielding portion m11 connected between adjacent two bases dz. The second shielding portion m2 includes the base dz and the column shielding portion m21 connected between adjacent two bases dz. That is, the first shielding portion m1 and the second shielding portion m2 share the same base dz.

The width of the base dz is greater than the width of the column shielding portion m21 in the extension direction (the first direction x) of the first shielding portion m1, and the width of the base dz is greater than the width of the row shielding portion m11 in the direction perpendicular to the extension direction (the first direction x) of the first shielding portion m1. This setting ensures that the base dz completely shields the padding ps. By setting the first thin film transistor t1 partially overlapping with the second thin film transistor t2 in the first direction x, the size of the row line group z1 along the first direction x can be reduced, thereby improving the aperture ratio.

In an embodiment, the first thin film transistor t1 includes the first active layer 141, and the first active layer 141 includes a first portion 14a and a second portion 14b connected to the first portion 14a. An extension direction of the first portion 14a intersects with an extension direction of the second portion 14b.

In the same row line group z1, the first scanning line 111 overlaps with the first portion 14a and the second portion 14b. A part of the first scanning line 111 overlapping with the first portion 14a and the second portion 14b is multiplexed as the gate of the first thin film transistor t1.

The first active layer 141 is arranged in a bending manner, which can shorten the space of the first shielding portion m1 in the extension direction x compared with the straight line arrangement, thereby saving the layout space of the first thin film transistor t1.

In an embodiment, the first scanning line 111 includes multiple first turning portions la and a first connecting portion 1b connected between adjacent two first turning portions 1a. Each of the first turning portions 1a includes a first segment 1a1, a second segment 1a2, and a third segment 1a3 sequentially connected to each other. An extension direction of the first segment 1a1 intersects with an extension direction of the second segment 1a2, and the extension direction of the second segment 1a2 intersects with an extension direction of the third segment 1a3. Both of the first segment 1a1 and the third segment 1a3 are connected to a side of the second segment 1a2 close to the second scanning line 112. One end of the first connecting portion 1b is connected to the first segment 1a1 of one first turning portion la, and the other end of the first connecting portion 1b is connected to the third segment 1a3 of the other first turning portion 1a.

The first connecting portion 1b overlaps with the first portion 14a, and the first segment 1a1 overlaps with the second portion 14b.

Optionally, the first portion 14a intersects with and is connected to the second portion 14b, and the first connecting portion 1b intersects with the first portion 14a in different layers. Both of the extension direction of the first segment 1a1 and the extension direction of the third segment 1a3 are perpendicular to the extension direction of the second segment 1a2, and an extension direction of the first connecting portion 1b is parallel to the extension direction of the second segment 1a2.

Optionally, the first portion 14a overlaps with the data line 12 to save space.

In an embodiment, the second thin film transistor t2 includes the second active layer 142. The second active layer 142 includes a third portion 14c and a fourth portion 14d connected to the third portion 14c. An extension direction of the third portion 14c intersects with an extension direction of the fourth portion 14d.

In the same row line group z1, the second scanning line 112 overlaps with the third portion 14c and the fourth portion 14d, and a part of the second scanning line 112 overlapping with the third portion 14c and the fourth portion 14d is multiplexed as the gate of the second thin film transistor t2.

The second active layer 142 is arranged in a bending manner, which can shorten the space of the first shielding portion m1 in the extension direction x compared with the straight line arrangement, thereby saving the layout space of the second thin film transistor t2.

Optionally, the third portion 14c intersects with and is connected to the fourth portion 14d.

In an embodiment, the second scanning line 112 includes multiple second turning portions 1c and a second connecting portion 1d connected between adjacent two second turning portions 1c. Each of the second turning portion 1c includes a fourth segment 1c1, a fifth segment 1c2, and a sixth segment 1c3 sequentially connected to each other. An extension direction of the fourth segment 1c1 intersects with an extension direction of the fifth segment 1c2, and the extension direction of the fifth segment 1c2 intersects with an extension direction of the sixth segment 1c3. Both of the fourth segment 1c1 and the sixth segment 1c3 are connected to a side of the fifth segment 1c2 away from the first scanning line 111. One end of the second connecting portion 1d is connected to the fourth segment 1c1 of one first second turning portion 1c, and the other end of the second connecting portion 1d is connected to the sixth segment 1c3 of the other second turning portion 1c.

The fourth segment 1c1 overlaps with the third portion 14c, and the fifth segment 1c2 overlaps with the fourth portion 14d.

Optionally, the fourth segment 1c1 intersects with the third portion 14c in different layers. Both of the extension direction of the fourth segment 1c1 and the extension direction of the sixth segment 1c3 are perpendicular to the extension direction of the fifth segment 1c2, and an extension direction of the second connecting portion 1d is parallel to the extension direction of the fifth segment 1c2.

Optionally, the first turning portion 1a is aligned with the second turning portion 1c and the first connecting portion 1b is aligned with the second connecting portion 1d in the direction perpendicular to the first direction x, so as to save space in the first direction x.

Along the first direction x, the extension direction of the fifth segment 1c2 and the extension direction of the first connecting portion 1b are the same, the fifth segment 1c2 and the first connecting portion 1b are alternately arranged, and the fifth segment 1c2 is aligned with the first connecting portion 1b, so as to save space perpendicular to the first direction x.

In an embodiment, the first portion 14a intersects with and is connected to the third portion 14c. The first thin film transistor t1 and the second thin film transistor t2 share a common input pole 151. The common input pole 151 is connected to the data line 12 at the intersection of the first portion 14a and the third portion 14c.

Optionally, the first portion 14a intersects with and is connected to the third portion 14c. The first thin film transistor t1 and the second thin film transistor t2 can share one input pole to save one input pole, thereby saving space.

In an embodiment, the output pole d1 of the first thin-film transistor t1 and the output pole d2 of the second thin-film transistor t2 are adjacent in the region defined by the first turning portion 1a and the fifth segment 1c2. The common input pole 151 is disposed between the first connecting portion 1b and the second connecting portion 1d.

That is, the output poles d1 and d2 are disposed in the space formed by the first turning portion 1a, and the common input pole 151 is disposed in the space formed by the connection of the sixth segment 1c3, the second connecting portion 1d, and the fourth segment 1c1, which saves space and avoids the formation of parasitic capacitance formed by the output poles d1 and d2 and the first scanning line 111 and the second scanning line 112, respectively.

Optionally, the common input pole 151 is connected to the intersection of the first active layer 141 and the second active layer 142 through one first via h1, and the output pole d1 of the first thin-film transistor t1 is connected to the first active layer 141 through another first via h1. The output pole d1 of the first thin-film transistor t1 is connected to the first pixel electrode p1 through one second via h2.

Optionally, the data line 12 is connected to the common input pole 151 through one first via h1. In the orthographic projection pattern of the liquid crystal display panel 100, the data line 12, the first via h1, and the common input pole 151 are disposed overlapping with each other to save space for disposing the first via h1, thereby improving the aperture ratio.

The output pole d2 of the second thin film transistor t2 is connected to the second active layer 142 through the third via h3. The output pole d2 of the second thin film transistor t2 is connected to the second pixel electrode p2 through the fourth via h4.

Optionally, in the first direction, a length of the second connecting portion 1d is greater than a length of the first connecting portion 1b, and a length of the first turning portion la is greater than a length of the second turning portion 1c.

When both of the first active layer 141 of the double gate first thin film transistor t1 and the second active layer 142 of the double gate second thin film transistor t2 are in an “L” shape, the aperture ratio of the liquid crystal display panel provided by the embodiments of the present disclosure can be increased by 5.8% to 9.9% compared with the liquid crystal panel with the configuration of the single scanning line (shown in FIG. 1).

In the liquid crystal display panel provided in the embodiments of the present disclosure, in the orthographic projection pattern of the liquid crystal display panel, two rows of pixel electrodes are disposed between adjacent two row line groups, the paddings are stacked on the row line group, and the first shielding portions of the black matrix layer completely cover the row line group and the paddings. In the present disclosure, the paddings, two scanning lines, and the thin film transistors connected to the two scanning lines are disposed in the region where one row line group is located, so that the first shielding portions cover the paddings, two scanning lines, and the thin film transistors connected to the two scanning lines. Compared with the design of the single scanning line, the present disclosure avoids the excessive waste of the aperture ratio caused by a width of the region where the paddings in each row are located exceeding a width of the region where the single scanning line is located, thereby improving the aperture ratio of the liquid crystal display panel without sacrificing performances of products, such as reducing sizes of scanning lines and thin-film transistors.

The above provides a detailed description of the liquid crystal display panel provided in the embodiments of the present disclosure. This context uses specific embodiments to explain the principles and implementation manners of the liquid crystal display panel of the present disclosure. The embodiments are only used to help understand the methods and core ideas of the present disclosure. Meanwhile, for any person skill in the art, there may be changes in specific implementation methods and application scopes based on the core ideas of the present disclosure. The content of this specification should not be understood as a limitation on the present disclosure.

What is claimed is:

1. A liquid crystal display panel comprising:
a black matrix layer provided with a plurality of pixel openings, wherein the black matrix layer comprises a plurality of first shielding portions disposed along a first direction, and the first shielding portions are disposed between adjacent two rows of pixel openings;
an array substrate comprising a plurality of pixel electrodes, a plurality of scanning lines disposed along the first direction, and a plurality of thin film transistors; wherein the pixel electrodes are disposed corresponding to the pixel openings; in an orthographic projection pattern of the liquid crystal display panel, adjacent two scanning lines are disposed between adjacent two rows of pixel openings, and the first shielding portions cover the scanning lines and the thin film transistors; and the scanning lines are connected to gates of the thin film transistors; and
a plurality of paddings disposed on the array substrate, wherein in the orthographic projection pattern of the liquid crystal display panel, the first shielding portions cover the paddings.

2. The liquid crystal display panel of claim 1, wherein the black matrix layer further comprises a plurality of third shielding portions, the array substrate further comprises a plurality of common electrode lines extending along the first direction, and the third shielding portions cover the common electrode lines; wherein two rows of pixel openings are disposed between adjacent two first shielding portions, and one of the common electrode lines is disposed between two rows of pixel openings and between two first shielding portions.

3. The liquid crystal display panel of claim 2, wherein a width of the third shielding portions is less than a width of the first shielding portions m1.

4. The liquid crystal display panel of claim 2, wherein the array substrate further comprises a plurality of data lines disposed along a second direction intersecting with the first direction;
in the orthographic projection pattern of the liquid crystal display panel, the data lines intersect with the scanning lines and the common electrode lines respectively; one of the pixel electrodes comprises a first pixel electrode and a second pixel electrode;
the first pixel electrode corresponds to one of the pixel openings, the second pixel electrode corresponds to one of the pixel openings; one of the scanning lines comprises a first scanning line and a second scanning line; one of the thin film transistors comprises a first thin film transistor and a second thin film transistor; a gate of the first thin film transistor is connected to the first scanning line, a gate of the second thin film transistor is connected to the second scanning line, an output pole of the first thin-film transistor is connected to the first pixel electrode, and an output pole of the second thin-film transistor is connected to the second pixel electrode; one of the common electrode lines is spaced between a side of the first pixel electrode away from the first thin-film transistor and a side of the second pixel electrode away from the second thin-film transistor, and the first scanning line and the second scanning line are spaced between a side of the first pixel electrode close to the first thin film transistor and a side of the second pixel electrode close to the second thin film transistor; and
the black matrix layer comprises a plurality of second shielding portions, and the first shielding portions intersect with and are connected to the second shielding portions; wherein in the orthographic projection pattern of the liquid crystal display panel, one of the first shielding portions, one of the pixel openings, one of the third shielding portions, and another one of the pixel openings are alternately arranged in a direction perpendicular to the first direction, and the second shielding portions cover the data lines.

5. The liquid crystal display panel of claim 4, wherein in the orthographic projection pattern of the liquid crystal display panel, the plurality of paddings are arranged in rows along the first direction, and a row of first pixel electrodes and a row of second pixel electrodes are disposed between adjacent two rows of the paddings in the direction perpendicular to the first direction.

6. The liquid crystal display panel of claim 4, wherein in the orthographic projection pattern of the liquid crystal display panel, one of the paddings is disposed at an intersection of one of the first shielding portions and one of the second shielding portions; and
the paddings partially overlap with the first scanning line, the second scanning line, and one of the data lines.

7. The liquid crystal display panel of claim 6, wherein in the orthographic projection pattern of the liquid crystal display panel, in the direction perpendicular to the first direction, a region where the paddings are located has a first width, a region where the first scanning line and the first thin film transistor connected thereto are located has a second width, a region where the second scanning line and the second thin film transistor connected thereto are located has a third width, and the first width is greater than the second width and the third width and less than or equal to a sum of the second width and the third width.

8. The liquid crystal display panel of claim 7, wherein in the orthographic projection pattern of the liquid crystal display panel, the first thin-film transistor is disposed at a side of the first scanning line away from the second scanning line, and the second thin-film transistor is disposed at a side of the second scanning line away from the first scanning line and aligned with the first thin-film transistor.

9. The liquid crystal display panel of claim 8, wherein the first scanning line comprises a first main line and at least one first extension portion, wherein the first extension portion is connected to a side of the first main line away from the second scanning line and the gate of the first thin film transistor; and
the first thin film transistor comprises a first active layer, and in the orthographic projection pattern of the liquid crystal display panel, the first active layer overlaps with the gate of the first thin film transistor.

10. The liquid crystal display panel of claim 9, wherein the first active layer extends along an extension direction of the first main line, an extension direction of the first extension portion intersects with the extension direction of the first main line, and the first active layer overlaps with two first extension portions.

11. The liquid crystal display panel of claim 6, wherein in the orthographic projection pattern of the liquid crystal display panel, the first thin film transistor partially overlaps with the second thin film transistor along the first direction;
one of the first shielding portions comprises a base and a row shielding portion connected to the base; wherein in the orthographic projection pattern of the liquid crystal display panel, the base completely covers one of the paddings, the base covers a part of one of the scanning lines and one of the thin film transistors, and the row shielding portion covers another part of the one of the scanning lines and the one of the thin film transistors;
wherein a width of the base is greater than a width of the row shielding portion in the direction perpendicular to the first direction.

12. The liquid crystal display panel of claim 11, wherein the first thin film transistor comprises a first active layer, wherein the first active layer comprises a first portion and a second portion connected to the first portion, and an extension direction of the first portion intersects with an extension direction of the second portion; and
the first scanning line overlaps with the first portion and the second portion, and a part of the first scanning line overlapping with the first portion and the second portion is multiplexed as the gate of the first thin film transistor.

13. The liquid crystal display panel of claim 12, wherein the first scanning line comprises a plurality of first turning portions and a first connecting portion connected between adjacent two first turning portions, and each of the first turning portions comprises a first segment, a second segment, and a third segment sequentially connected to each other; wherein an extension direction of the first segment intersects with an extension direction of the second segment, the extension direction of the second segment intersects with an extension direction of the third segment; and both of the first segment and the third segment are connected to a side of the second segment close to the second scanning line, an end of the first connecting portion is connected to the first segment of one of the first turning portions, and another end of the first connecting portion is connected to the third segment of another one of the first turning portions; and
the first connecting portion overlaps with the first portion, and the first segment overlaps with the second portion.

14. The liquid crystal display panel of claim 13, wherein the second thin film transistor comprises a second active layer, wherein the second active layer comprises a third portion and a fourth portion connected to the third portion, and an extension direction of the third portion intersects with an extension direction of the fourth portion; and
the second scanning line overlaps with the third portion and the fourth portion, and a part of the second scanning line overlapping with the third portion and the fourth portion is multiplexed as the gate of the second thin film transistor.

15. The liquid crystal display panel of claim 14, wherein the second scanning line comprises a plurality of second turning portions and a second connecting portion connected between adjacent two second turning portions, and each of the second turning portions comprises a fourth segment, a fifth segment, and a sixth segment sequentially connected to each other; wherein an extension direction of the fourth segment intersects with an extension direction of the fifth segment, the extension direction of the fifth segment intersects with an extension direction of the sixth segment; and both of the fourth segment and the sixth segment are connected to a side of the fifth segment away from the first scanning line, an end of the second connecting portion is connected to the fourth segment of one of the second turning portions, and another end of the second connecting portion is connected to the sixth segment of another one of the second turning portions; and
the fourth segment overlaps with the third portion, and the fifth segment overlaps with the fourth portion.

16. The liquid crystal display panel of claim 15, wherein the first turning portions are aligned with the second turning portions in the direction perpendicular to the first direction, and the first connecting portion is aligned with the second connecting portion; and
along the first direction, the extension direction of the fifth segment and an extension direction of the first connecting portion are the same, the fifth segment and the first connecting portion are alternately arranged, and the fifth segment is aligned with the first connecting portion.

17. The liquid crystal display panel of claim 16, wherein the first portion intersects with and is connected to the third portion, the first thin film transistor and the second thin film transistor share a common input pole, and the common input pole is connected to one of the data lines and connected to an intersection of the first portion and the third portion.

18. The liquid crystal display panel of claim 17, wherein one of the data lines is connected to the common input pole through a first via, and in the orthographic projection pattern of the liquid crystal display panel, one of the data lines, the first via, and the common input pole are disposed overlapping with each other.

19. The liquid crystal display panel of claim 17, wherein the output pole of the first thin-film transistor and the output pole of the second thin-film transistor are adjacent in a region defined by one of the first turning portions and the fifth segment, and the common input pole is disposed between the first connecting portion and the second connecting portion.

20. The liquid crystal display panel of claim 6, further comprising an opposing substrate disposed opposite to the array substrate, wherein the black matrix layer is integrated into the opposing substrate or the array substrate, and the paddings are integrated into the opposing substrate or the array substrate.
